(19) United States
(12) Patent Application Publication
(10) Pub. No.: US 2021/0274860 A1
(43) Pub. Date: Sep. 9, 2021

(54) Mask Capable of Protecting Spectacles against Mist

(71) Applicant: PUTIAN JIANQIANG SEWING EQUIPMENT CO., LTD., Putian (CN)

(72) Inventors: Zhijian Lin, Putian (CN); Zhiqiang Lin, Putian (CN); Yanzhong Xu, Putian (CN)

(21) Appl. No.: 16/833,659

(22) Filed: Mar. 29, 2020

(30) Foreign Application Priority Data
Mar. 5, 2020 (CN) 202010147191.X

(51) Int. Cl. A41D 13/11

(52) U.S. Cl. CPC A41D 13/11

(57) ABSTRACT

The invention relates to the field of sanitary products, in particular to a mask capable of preventing spectacles against mist. The mask comprises a mask body having an external surface and an internal surface, and a sponge strip fixedly connected to an upper part of the internal surface of the mask body. The side, away from the mask body, of the sponge strip is concave-convex to fit the nose bridge. The invention has the following beneficial effects: the sponge strip can well fit the nose bridge of the face of a wearer in shape, the sponge strip is compressible, the sponge strip will be squeezed by the mask body and the face of the wearer to deform to perfectly fit the face of different wearers; and the sponge is soft, so that the wear comfort of the mask can be improved.

### CROSS REFERENCE TO RELATED APPLICATIONS

The present application claims the benefit of Chinese Patent Application No. 202010147191.X filed on Mar. 5, 2020, the contents of which are incorporated herein by reference in their entirety.

### TECHNICAL FIELD

The invention relates to the field of sanitary products, in particular to a mask capable of protecting spectacles against mist.

### DESCRIPTION OF RELATED ART

Masks, as sanitary products, are typically worn over the mouth and nose to filter air inhaled into the mouth and nose to prevent harmful gases, odors and respiratory droplets from entering or coming out of the mouth and nose of wearers, and are made of gauze, paper or the like.

To fulfill a filter effect, the mask body of traditional masks usually has a large respiratory resistance. Although a bendable and deformable nose bridge rib is inlaid in the top of the traditional masks to fit the nose bridge of wearers in shape to ensure that the masks are well attached to the nose bridge, hot air exhausted via a gap between the masks and the nose bridge will be condensed on spectacle lenses to form mist, which in turn affect the sight of wearers who wear both the masks and spectacles.

### BRIEF SUMMARY OF THE INVENTION

The invention aims to solve the technical problem that air may be exhausted via a gap between the top of traditional masks and the nose bridge of wearers and then be condensed on spectacle lenses to form mist.

The technical solution adopted by the invention to solve the above-mentioned technical problem is as follows: a mask capable of protecting spectacles against mist comprises a mask body having an external surface and an internal surface, and a sponge strip, wherein:

The sponge strip is fixedly connected to an upper part of the internal surface of the mask body;

The side, away from the mask body, of the sponge strip is concave-convex to fit the nose bridge.

The invention has the following beneficial effects: the sponge strip can well fit the nose bridge of the face of a wearer in shape, so that a gap will not be formed between the mask body and the nose bridge of the wearer after the mask is worn by the wearer; the sponge strip is compressible, so that after the mask is worn by the wearer, the sponge strip will be squeezed by the mask body and the face of the wearer to deform to perfectly fit the face of different wearers; and the sponge is soft, so that the wear comfort of the mask can be improved.

### BRIEF DESCRIPTION OF THE SEVERAL VIEWS OF THE DRAWINGS

FIG. 1 is a structural diagram of the front side of a mask capable of protecting spectacles against mist in one specific implementation of the invention;

FIG. 2 is a structural diagram of the back side of the mask capable of protecting spectacles against mist in the specific implementation of the invention;

FIG. 3 is a structural diagram of a sponge strip in the specific implementation of the invention.

### REFERENCE SIGNS

1, mask body; 2, sponge strip; 21, trough; 22, ridge; 3, silica gel layer.

### DETAILED DESCRIPTION OF THE INVENTION

The technical contents, objectives and effects of the invention are expounded below in conjunction with the implementations and accompanying drawings.

The key concept of the invention lies in that a sponge strip is arranged on a mask to prevent a gap from being formed between a mask body and the nose bridge of a wearer after the mask is worn by the wearer, so that air expired by the wearer will not be exhausted via the gap and will not be condensed on spectacles to form mist either.

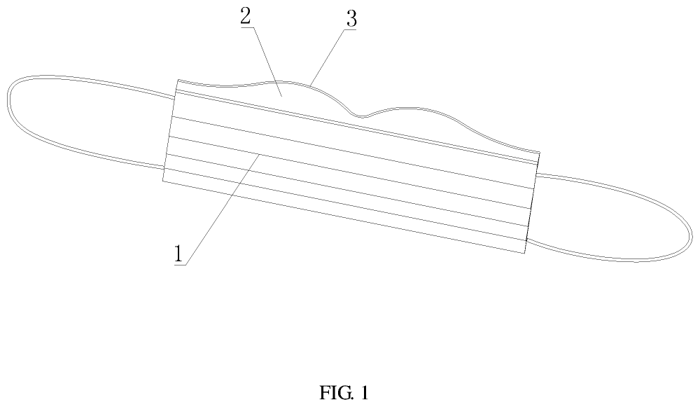

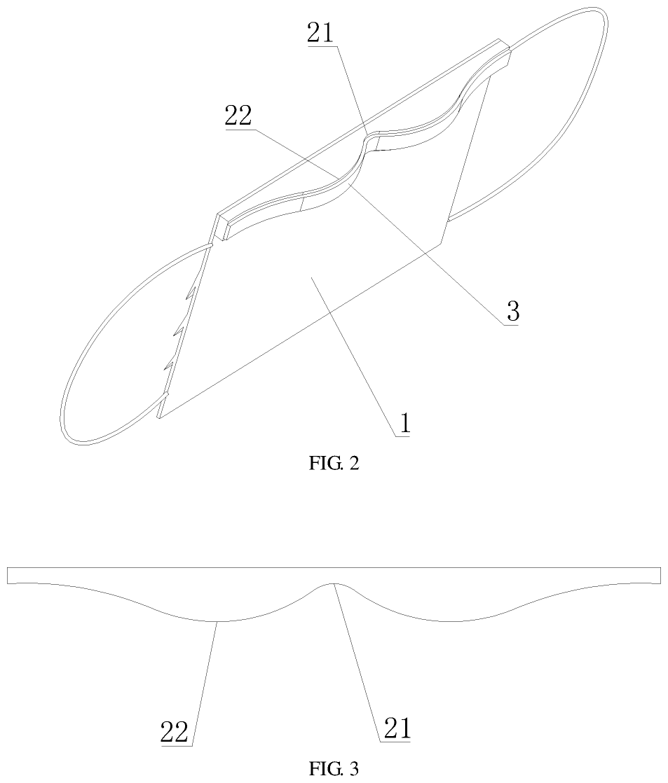

Referring to FIG. 1 to FIG. 3, the invention provides a mask capable of preventing spectacles against mist, which comprises a mask body 1 having an external surface and an internal surface, and a sponge strip 2;

The sponge strip 2 is fixedly connected to an upper part of the internal surface of the mask body 1;

The side, away from the mask body 1, of the sponge strip 2 is concave-convex to fit the nose bridge.

The operating principle of the invention lies in that after the mask is worn by a wearer, the sponge strip 2 will fit the nose bridge of the face of the wearer in shape to prevent expired air from being exhausted from the top of the mask, thus protecting the surfaces of spectacles against mist caused by condensation of the expired air.

From the above description, the invention has the following beneficial effects: the sponge strip well fits the nose bridge of the face of the wearer in shape, so that a gap will not be formed between the mask body and the nose bridge of the wearer after the mask is worn by the wearer; the sponge strip is compressible, so that after the mask is worn by the wearer, the sponge strip will be squeezed by the mask body and the face of the wearer to deform to perfectly fit the face of different wearers; and the sponge is soft, so that the wear comfort of the mask can be improved.

Furthermore, the mask capable of preventing spectacles against mist further comprises a silica gel layer 3 which is fixedly connected to the side, away from the mask body 1, of the sponge strip 2.

From the above description, the silica gel layer arranged on the side, away from the mask body, of the sponge strip further improves the wear comfort of the mask; and the direct frictional force between the silica gel layer and the skin of the wearer is large, so that the mask will not fall after being worn by the wearers.

Furthermore, a trough 21 and two ridges 22 are arranged on the side, away from the mask body, of the sponge strip 2, wherein the trough 21 is located in the middle of the sponge strip 2, and the two ridges 22 are symmetrically arranged on the two sides of the trough 21.

From the above description, the trough of the sponge strip fits the nose bridge of the face of wearer, and the two ridges exactly fit concave parts on the two sides of the nose bridge of the face of the wearer, so that the wear comfort of the mask is improved.

Furthermore, the height of the sponge strip 2 is 6 mm-16 mm.

Furthermore, the thickness of the trough 21 of the sponge strip 2 is 1 mm-10 mm, and the thickness of the ridges 22 of the sponge strip 2 is 5 mm-15 mm.

From the above description, the cost of raw materials can be reduced with the thickness decrease of the trough and the ridges, and the sponge strip can be more easily squeezed to deform after the mask is worn with the thickness increase of the trough and the ridges, so that the breathability of the sponge strip is further reduced, the protection capacity of the mask is improved, and air is further prevented from being exhausted via the gap.

Furthermore, the thickness of the trough 21 of the sponge strip 2 is 3 mm, and the thickness of the ridges 22 of the sponge strip 2 is 10 mm.

From the above description, it is verified by repeated experiments that when the thickness of the trough of the sponge strip is set to 3 mm, air can be effectively prevented from being exhausted via the gap, and the cost is minimized; and the thickness of the ridges is set to 10 mm according to the height of the nose bridge of the face of the wearer, so that the sponge strip is able to fit the face of most adults.

Furthermore, the thickness of the two ends of the sponge strip 2 is 1 mm-5 mm.

Furthermore, the thickness of the two ends of the sponge strip 2 is 3 mm.

Furthermore, the sponge strip 2 is a non-breathable sponge strip 2.

### Embodiment 1

A mask capable of protecting spectacles against mist and suitable for adults comprises a mask body 1 having an external surface and an internal surface, and a sponge strip 2, wherein the sponge strip 2 is a non-breathable sponge strip 2 and is fixedly connected to an upper part of the internal surface of the mask body 1;

The side, away from the mask body 1, of the sponge strip 2 is concave-convex to fit the nose bridge; a trough 21 and two ridges 22 are arranged on the side, away from the mask body, of the sponge strip 2, the trough 21 is located in the middle of the sponge strip 2, and the two ridges 22 are symmetrically arranged on the two sides of the trough 21;

The height of the sponge strip is 10 mm, the thickness of the trough 21 of the sponge strip 2 is 3 mm, the thickness of the ridges 22 of the sponge strip 2 is 10 mm, and the thickness of the two ends of the sponge strip 2 is 3 mm.

### Embodiment 2

An anti-fall mask capable of protecting spectacles against mist comprises a mask body 1 having an internal surface and an external surface, and a sponge strip 2, wherein the sponge strip 2 is a non-breathable sponge strip 2 and is fixedly connected to an upper part of the internal surface of the mask body 1;

The side, away from the mask body 1, of the sponge strip 2 is concave-convex to fit the nose bridge; a trough 21 and two ridges 22 are arranged on the side, away from the mask body, of the sponge strip 2, the trough 21 is located in the middle of the sponge strip 2, and the two ridges 22 are symmetrically arranged on the two sides of the trough 21;

The height of the sponge strip 2 is 10 mm, the thickness of the trough 21 of the sponge strip 2 is 3 mm, the thickness of the ridges of the sponge strip 2 is 10 mm, and the thickness of the two ends of the sponge strip 2 is 3 mm;

The anti-fall mask capable of protecting spectacles against mist further comprises a silica gel layer 3 which is fixedly connected to the side, away from the mask body 1, of the sponge strip 2.

The silica gel is arranged on the sponge strip to improve the wear comfort of the mask; and the frictional force between the silica gel layer and the skin of the wearer is large, so that the mask will not fall after the silica gel layer is additionally arranged on the sponge strip.

### Embodiment 3

A mask capable of protecting spectacles against mist and suitable for children comprises a mask body 1 having an external surface and an internal surface, and a sponge strip 2, wherein the sponge strip 2 is a non-breathable sponge strip 2 and is fixedly connected to an upper part of the internal surface of the mask body 1;

The side, away from the mask body 1, of the sponge strip 2 is concave-convex to fit the nose bridge; a trough 21 and two ridges 22 are arranged on the side, away from the mask body, of the sponge strip 2, the trough 21 is located in the middle of the sponge strip 2, and the ridges 22 are symmetrically arranged on the two sides of the trough 21;

The height of the sponge strip 2 is 6 mm, the thickness of the trough 21 of the sponge strip 2 is 1 mm, the thickness of the ridges 22 of the sponge strip 2 is 5 mm, and the thickness of the two ends of the sponge strip 1 is 3 mm.

Because the nose bridge of children who have not been fully developed yet is low, the height difference between the trough and the ridges of the sponge strip in this embodiment is only 4 mm, so that compared with the mask capable of protecting spectacles against mist and suitable for adults in Embodiment 1, the mask in this embodiment can better fit the face of children, thus fulfilling a better anti-mist effect and a better protection effect.

### Embodiment 4

A mask capable of protecting spectacles against mist and having a better protection effect comprises a mask body 1 having an external surface and an internal surface, and a sponge strip 2, wherein the sponge strip 2 is a non-breathable sponge strip 2 and is fixedly connected to an upper part of the internal surface of the mask body 1;

The side, away from the mask body 1, of the sponge strip 2 is concave-convex to fit the nose bridge; a trough 21 and two ridges 22 are arranged on the side, away from the mask body, of the sponge strip 2, the trough 21 is located in the middle of the sponge strip 2, and the two ridges 22 are symmetrically arranged on the two sides of the trough 21.

The height of the sponge strip 2 is 16 mm, the thickness of the trough 21 of the sponge strip 2 is 10 mm, the thickness of the ridges 22 of the sponge strip 2 is 15 mm, and the thickness of the two ends of the sponge strip 1 is 5 mm.

The sponge strip in this embodiment has a large overall thickness, so that after the mask is worn by the wearer, the whole sponge strip will be compressed to have a more compact internal structure to prevent viruses, thus realizing an anti-mist effect and a better protection effect.

In conclusion, the invention has the following beneficial effects: the sponge strip can well fit the nose bridge of the face of the wearer in shape, so that a gap will not be formed between the mask body and the nose bridge of the wearer after the mask is worn by the wearer; the sponge strip is compressible, so that so that after the mask is worn by the wearer, the sponge strip will be squeezed by the mask body and the face of the wearer to deform to perfectly fit the face of different wearers; and the sponge is soft, so that the wear comfort of the mask can be improved; the silica gel layer arranged on the side, away from the mask body, of the sponge strip further improves the wear comfort of the mask; and the direct frictional force between the silica gel layer and the skin of the wearer is large, so that the mask will not fall after being worn by the wearer. The cost of raw materials can be reduced with the thickness decrease of the trough and the ridges, and the sponge strip can be more easily squeezed to deform after the mask is worn with the thickness increase of the trough and the ridges, so that the breathability of the sponge strip is further reduced, the protection capacity of the mask is improved, and air further prevented from being exhausted via the gap. It is verified by repeated experiments that when the thickness of the trough of the sponge strip is set to 3 mm, air can be effectively prevented from being exhausted via the gap, and the cost is minimized; and the thickness of the ridges is set to 10 mm according to the height of the nose bridge of the face of the wearer, so that the sponge strip is able to fit the face of most adults.

The above embodiments are only illustrative ones of the invention, and are not intended to limit the patent scope of the invention. All equivalent transformations made on the basis of the contents in the description and accompanying drawings, or direct or indirect applications to relating technical fields should also fall within the protection scope of the invention patent.

What is claimed is:

1. A mask capable of preventing spectacles against mist, comprising a mask body having an external surface and an internal surface, and a sponge strip, wherein:
the sponge strip is fixedly connected to an upper part of the internal surface of the mask body; and
a side, away from the mask body, of the sponge strip is concave-convex to fit a nose bridge.

2. The mask capable of preventing spectacles against mist according to claim 1, further comprising a silica gel layer fixedly connected to the side, away from the mask body, of the sponge strip.

3. The mask capable of preventing spectacles against mist according to claim 1, wherein a trough and two ridges are arranged on the side, away from the mask body, of the sponge strip, the trough is located in a middle of the trough, and the two ridges are symmetrically arranged on two sides of the trough.

4. The mask capable of preventing spectacles against mist according to claim 3, wherein the sponge strip has a height of 6 mm-16 mm.

5. The mask capable of preventing spectacles against mist according to claim 3, wherein the trough of the sponge strip has a thickness of 1 mm-10 mm, and the ridges of the sponge strip have a thickness of 5 mm-15 mm.

6. The mask capable of preventing spectacles against mist according to claim 5, wherein the trough of the sponge strip has a thickness of 3 mm, and the ridges of the sponge strip have a thickness of 10 mm.

7. The mask capable of preventing spectacles against mist according to claim 3, wherein two ends of the sponge strip have a thickness of 1 mm-5 mm.

8. The mask capable of preventing spectacles against mist according to claim 7, wherein the two ends of the sponge strip have a thickness of 3 mm.

9. The mask capable of preventing spectacles against mist according to claim 1, wherein the sponge strip is a non-breathable sponge strip.
